(19) United States
(12) Patent Application Publication
(10) Pub. No.: US 2024/0214309 A1
(43) Pub. Date: Jun. 27, 2024

(54) Packet Classification Using Lookup Tables with Different Key-widths

(71) Applicant: Arista Networks, Inc., Santa Clara, CA (US)

(72) Inventors: Michael Chih-Yen Wang, Vancouver (CA); Navdeep Bhatia, Sunnyvale, CA (US); Prasanna Parthasarathy, Cupertino, CA (US)

(21) Appl. No.: 18/146,617

(22) Filed: Dec. 27, 2022

(51) Int. Cl. H04L 45/7452; H04L 45/741

(52) U.S. Cl. CPC H04L 45/7452; H04L 45/741

(57) ABSTRACT

A multistaged packet processor includes a lookup table at each stage. In one configuration, the match criteria in the lookup tables across the stages of a four-stage packet processor allocate 32 bits of space to hold IPv4 addresses and IPv6 addresses. In one configuration, the 32 bits store an entire IPv4 address or a 32-bit segment. An IPv6 address can be stored across the four lookup tables in 32-bit segments. The configuration allows for accommodating the varying key widths presented by IPv4 and IPv6 addresses while at the same time improving storage utilization in the lookup tables.

### BACKGROUND

The present disclosure relates to packet classification and in particular to multistage packet classifiers. Packets can be classified in multiple stages, where actions (packet editing, data logging, flow control, etc.) can be applied at one or more of the stages. Each stage can include a lookup table, such as ternary content-addressable memory (TCAMs), exact match static random access memory (SRAMs), hash tables, etc. Lookups are sequentially performed from one stage to the next. Information in a lookup table entry found in one stage can be used to look up an entry in the lookup table of the next stage, and so on. As a practical matter, some stages can include multiple lookup tables for one or more features that need to be looked up.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 is a high level block diagram of a network device in accordance with the present disclosure.

FIG. 2 shows details for a packet classifier in accordance with some embodiments.

FIG. 3 shows lookup table in accordance with some embodiments.

FIG. 4 shows processing in a multistage packet processing in accordance with some embodiments.

FIG. 5 shows an illustrative example of lookup tables in accordance with some embodiments.

FIG. 6 shows an example of non-adjacent address segments.

### DETAILED DESCRIPTION

The present disclosure is directed to multistaged lookups that can accommodate lookups (searches) that use different key widths while at the same time avoiding underutilizing memory for the lookup tables. Consider for example, a lookup (search) key that includes (among other data fields in a packet) an Internet protocol (IP) address contained in the packet. A lookup key that includes a 32-bit IPv4 address (IPv4 key) would be narrower than a 128-bit IPv6 address (IPv6 key). A common solution that accommodates both IPv6 keys and IPv4 keys is to normalize the key width to the wider IPv6 key. The lookup tables in each stage can be configured for match criteria that are 128+x bits wide, comprising the 128-bit IPv6 address as one component of the match criteria and an x-bit component that includes other data (if any) from the data packet. It can be seen that match criteria containing IPv6 addresses are fully utilized, whereas match criteria that store IPv4 addresses are substantially underutilized (96 of the 128 bits are not used). Such solutions can be wasteful in a deployment that accommodates both IPv4 packets and IPv6 packets, but in which there are significantly more IPv4 packets than IPv6 packets.

In accordance with some embodiments, and continuing with the example of IPv4 and IPv6 addresses, the IPv6 address can be segmented into smaller segments, for example, 32-bit segments where segment S1 contains bits 0-31 of the key, S2 contains bits 32-63, S3 contains bits 64-95, and S4 contains bits 96-127. The match criteria in the lookup tables in each stage can be configured for 32-bit wide IP address fields. In this way, the match criteria are fully utilized irrespective of the IP address type; the match criteria can store a complete 32-bit IPv4 address or a 32-bit segment of an IPv6 address (IPv6 segment) and as such can accommodate both IPv4 and IPv6 addresses. The lookup tables can include a “type” field to indicate whether an entry contains an IPv4 address or an IPv6 address segment, and a “segment” field to chain together segments of an IPv6 address across stages. In general, the type field in the lookup table can be used to match any part of the incoming packet to determine if we have IPv4 or IPv6 packets.

In the following description, for purposes of explanation, numerous examples and specific details are set forth in order to provide a thorough understanding of embodiments of the present disclosure. Particular embodiments as expressed in the claims may include some or all of the features in these examples, alone or in combination with other features described below, and may further include modifications and equivalents of the features and concepts described herein.

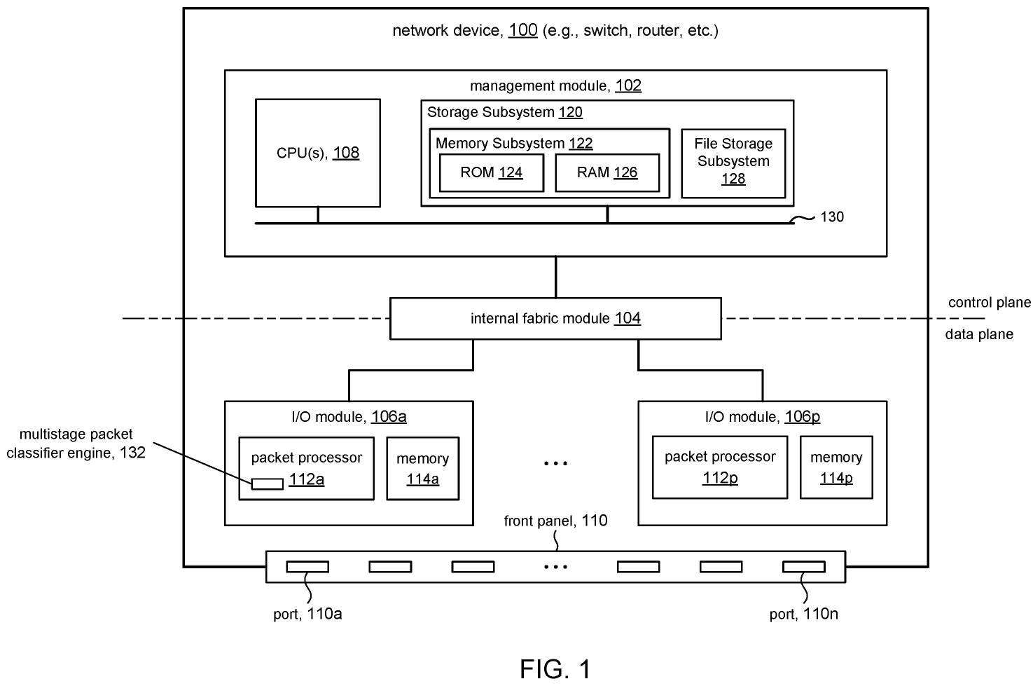

FIG. 1 is a schematic representation of a network device 100 (e.g., a router, switch, firewall, and the like) that can be adapted in accordance with the present disclosure. In some embodiments, for example, network device 100 can include a management module 102, an internal fabric module 104, a number of I/O modules 106a-106p, and a front panel 110 of I/O ports (physical interfaces) 110a-110n. Management module 102 can constitute the control plane (also referred to as a control layer or simply the CPU) of network device 100 and can include one or more management CPUs 108 for managing and controlling operation of network device 100 in accordance with the present disclosure. Each management CPU 108 can be a general-purpose processor, such as an Intel®/AMD® x86, ARM® microprocessor and the like, that operates under the control of software stored in a memory device, such as ROM (read-only memory) 124 or RAM (random-access memory) 126. The control plane provides services that include traffic management functions such as routing, security, load balancing, analysis, and the like.

The one or more management CPUs 108 can communicate with storage subsystem 120 via bus subsystem 130. Other subsystems, such as a network interface subsystem (not shown in FIG. 1), may be on bus subsystem 130. Storage subsystem 120 can include memory subsystem 122 and file/disk storage subsystem 128, which represent non-transitory computer-readable storage media that can store program code and/or data, which when executed by one or more management CPUs 108, can cause one or more management CPUs 108 to perform operations in accordance with embodiments of the present disclosure.

Memory subsystem 122 can include a number of memory devices such as main RAM 126 for storage of instructions and data during program execution, and ROM (read-only memory) 124 in which fixed instructions and data can be stored. File storage subsystem 128 can provide persistent (i.e., non-volatile) storage for program and data files, and can include storage technologies such as solid-state drive and/or other types of storage media known in the art.

Management CPUs 108 can run a network operating system stored in storage subsystem 120. A network operating system is a specialized operating system for network device 100. For example, the network operating system can be the Arista Extensible Operating System (EOS®), which is a fully programmable and highly modular, Linux-based network operating system, developed and sold/licensed by Arista Networks, Inc. of Santa Clara, California. Other network operating systems may be used.

Bus subsystem 130 can provide a mechanism for the various components and subsystems of management module 102 to communicate with each other as intended. Although bus subsystem 130 is shown schematically as a single bus, alternative embodiments of the bus subsystem can utilize multiple busses.

Internal fabric module 104 and I/O modules 106a-106p collectively represent the data plane of network device 100 (also referred to as data layer, forwarding plane, etc.). Internal fabric module 104 represents interconnections among the various other modules of network device 100. Each I/O module 106a-106p can include a packet processing pipeline, logically represented by respective packet processors 112a-112p and memory hardware 114a-114p, to provide packet processing and forwarding capability. Each I/O module 106a-106p can be further configured to communicate over one or more ports 110a-110n on the front panel 110 to receive and forward network traffic. Packet processors 112a-112p can comprise hardware (circuitry), including for example, data processing hardware such as an ASIC (application specific integrated circuit), FPGA (field programmable array), DPU (digital processing unit), and the like. Memory hardware 114a-114p can include lookup hardware, for example, content addressable memory such as TCAMs (ternary CAMs) and auxiliary memory such as SRAMs (static random access memory). The forwarding hardware in conjunction with the lookup hardware can provide wire speed decisions on how to process ingress packets and outgoing packets for egress. In accordance with some embodiments, some aspects of the present disclosure can be performed wholly within the data plane.

Each packet processor (e.g., 112a) can include a multistage packet classifier engine 132 in accordance with the present disclosure for classifying IP packets. Packet classification categorizes packets into flows so that different actions can be applied to each flow. An illustrative, non-exhaustive, example of actions includes editing the packets in a flow (e.g., add, strip, or edit destination address, labels, tags, etc.), dropping the packet, policing, logging information, and so on.

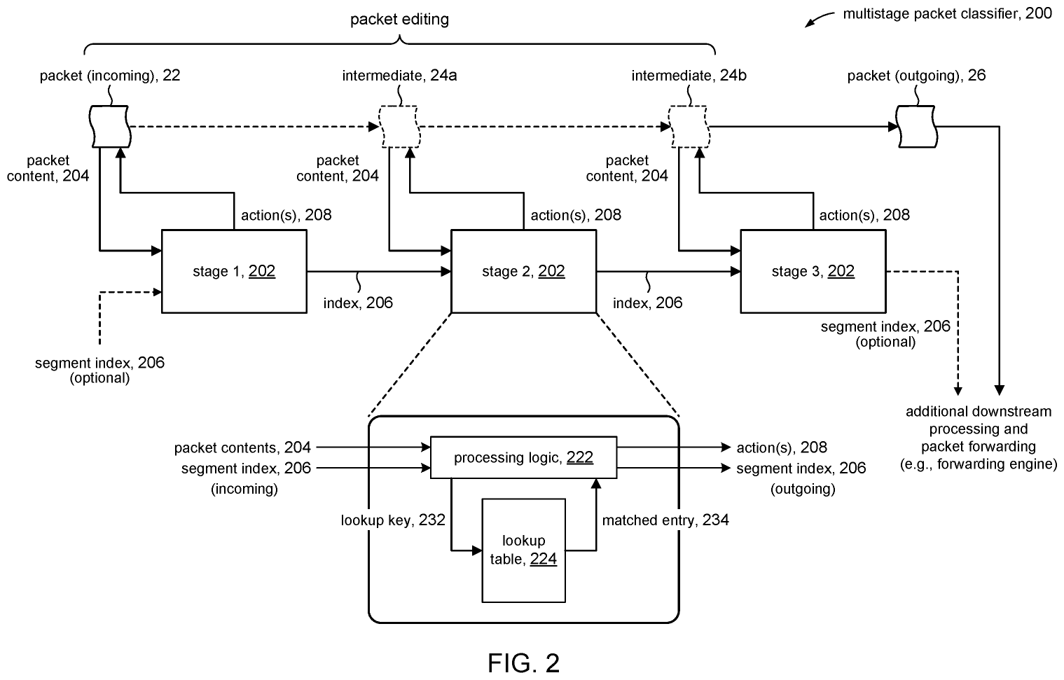

FIG. 2 is a schematic representation of a multistaged packet classification process in the packet processor (e.g., 112a) of a network device in accordance with some embodiments of the present disclosure. The general idea of multistaged packet classification is understood. Briefly at a high level, at each stage of the classifier, portions of the packet can be used as a lookup (search) key to determine or otherwise identify one or more actions in a lookup table in that stage. The one or more actions can be applied to the packet from stage to stage. FIG. 2 shows an n-stage packet classifier 200, where merely for discussion purposes n=3, although it will be appreciated that n can be any suitable value for other configurations of the classifier.

The example 3-stage packet classifier 200 comprises three classifier stages 202: Stage 1, Stage 2, Stage 3. In some embodiments, each stage can receive two inputs: packet content 204 and segment index 206. Each stage can produce two outputs: action 208 and a segment index 206. Action 208 corresponds to one or more actions that are associated with the packet that is being classified. In some embodiments, action 208 can be an index that identifies or otherwise corresponds to actions to be performed in connection with the packet; e.g., the index can be provided to an editor (not shown) that actually edits the packet. In other embodiments, action 208 can represent the actual actions performed by the classifier stage itself. It is noted that action 208 can include non-packet editing actions (e.g., dropping packets, logging information, policing packets, etc.).

As shown in FIG. 2, in some embodiments, each packet classifier 202 can comprise its own processing logic 222 and one or more lookup tables 224. In accordance with some embodiments, the processing logic can generate a lookup (search) key 232 using packet contents 204 and segment index 206. A lookup operation can be performed on lookup table to obtain a matched entry 234. In some embodiments, for the processing logic 222 can be any suitable processing device with supporting chips, including but not limited to technologies such as FPGA, ASIC, data processing chips (e.g., CPU, etc.), and so on. Lookup table 224 can be any suitable memory device. In some embodiments, for example, the underlying hardware for lookup table 224 can be based on but not limited to memory architectures such as TCAM, algorithmic TCAM (ATCAM), exact match SRAM, etc. Lookup table 224 can be a hash table, and so on.

At each stage in the multistage packet classifier, packet content 204 comprises portions of the packet on which to perform a lookup. As shown in the example in FIG. 2, for instance, portions of incoming packet 22 are provided to Stage 1, portions of intermediate packet 24a are provided to Stage 2, and so on. In some embodiments, the packet content 204 can comprise fields in the header of the packet (MAC header, IP header, VLAN tags, etc.), and more generally can comprise any parts of the packet.

In accordance with the present disclosure, each stage can receive as input, data referred to herein as a segment index 206. The segment index into a given stage can come from a previous stage. In various embodiments, the first stage (e.g., Stage 1) may or may not receive a segment index. Likewise, in various embodiments, the final stage (e.g., Stage 3) may or may not produce a segment index.

In operation, incoming packet 22 enters packet classifier 200 and can be edited at each stage of the classifier to produce an egress packet 26. It will be understood that outgoing packet 26 can be further processed within the packet processor and eventually forwarded to a next hop. For example, although not shown in FIG. 2, a downstream forwarding engine can perform lookups in forwarding tables (e.g., next hop table, MAC table, etc.) to generate information such as destination addresses, egress port, and so on for egressing the outgoing packet 26 to a next hop device.

Processing of an incoming packet 22 by the multistage packet classifier 200 can generally proceed as follows. Portions (packet content 204) of incoming packet 22 can be provided to Stage 1 of packet classifier 200. In some embodiments a segment index can also be provided to Stage 1, while in other embodiments a segment index is not used in Stage 1. The Stage 1 processing logic can use these inputs to perform a lookup in the Stage 1 lookup table. A hit from the Stage 1 lookup table can be used by the Stage 1 processing logic to output/produce action(s) 208 and segment index 206. The action(s) 208 from Stage 1, if any, can be applied to the incoming packet 22 to create an intermediate packet 24a. For example, in the case of access control lists (ACLs) the packet may be edited. On the other hand, there may not be any edit actions in the case of a routing lookup.

Processing can proceed to the next stage, Stage 2, in packet classifier 200. Packet content from the intermediate packet 24a and the segment index from Stage 1 can be input to Stage 2. Like Stage 1, Stage 2 can use its inputs to search the Stage 2 lookup table, and output actions(s) 208 and segment index 206 based on a hit from the lookup. The action(s) 208 from Stage 2 can be applied to intermediate packet 24a to create an intermediate packet 24b.

Processing can proceed to the next stage, Stage 3. Packet content from the intermediate packet 24b and the segment index from Stage 2 can be input to Stage 3. Like Stage 1 and Stage 2, Stage 3 can output actions(s) 208, if any, that can be applied to intermediate packet 24b to create outgoing packet 26. In some embodiments, Stage 3, being the last stage of packet classifier 200, does not output a segment index. However in other embodiments, although not shown in FIG. 2, Stage 3 can output a segment index that can be used for further downstream processing.

Packet content 204 for a given stage can be used in the given stage to perform a lookup operation. As noted above, information used to do the lookup can vary in size from one packet to another. For example, a lookup key that includes the IP address in a packet can have a different key width depending on whether the packet is an IPv4 packet or an IPv6 packet. In accordance with the present disclosure, the IP address can be segmented across several stages to accommodate the different widths. The segment index 206 can chain together a lookup operation across multiple segments to process a lookup using the segmented IP address.

The discussion will now turn to details of an example of a multistaged packet classifier in accordance with the present disclosure. As noted above, the present disclosure is directed to staged lookups in a multistaged packet classifier that can accommodate lookup (searches) that have different widths. For discussion purposes, we will consider a lookup key 232 that includes the IP address (e.g., the destination IP) contained in a packet. The IP address field of the lookup key can be a 32-bit IPv4 address or a portion of a 128-bit IPv6 address. In accordance with some embodiments of the present disclosure, the wider IPv6 address can be segmented into smaller segments and stored across multiple lookup tables.

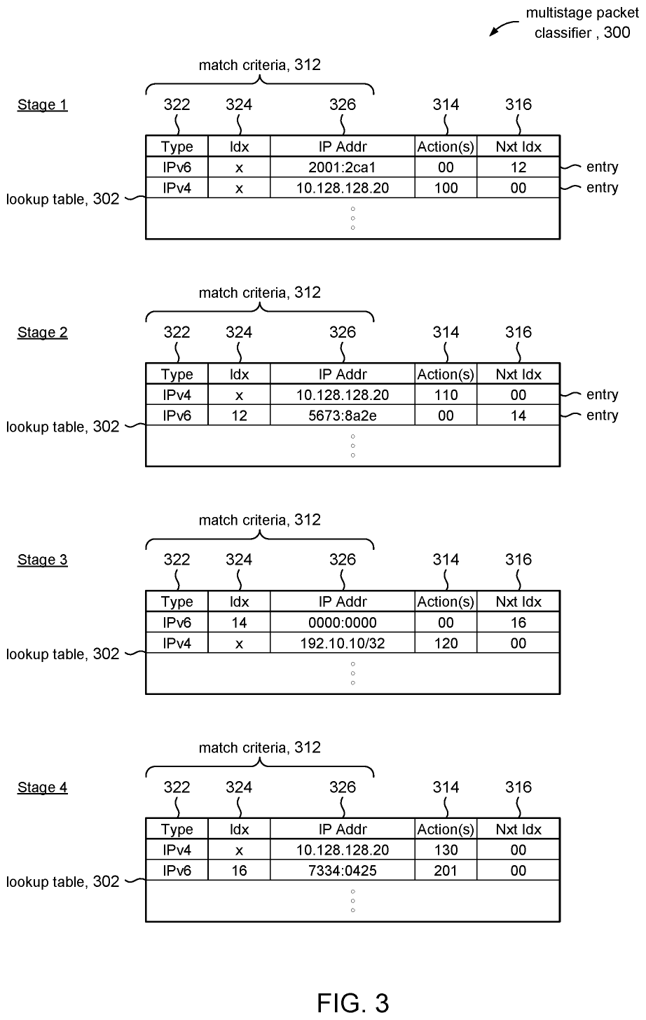

FIG. 3 shows a simplified illustrative example of lookup tables 302 in the stages of a multistage packet classifier 300 in accordance with some embodiments of the present disclosure. The figure shows the lookup tables in a four-stage packet classifier. Each lookup table can include the following data fields: match criteria 312, an action field 314, and a segment index field 316. It will be understood that in other embodiments, the lookup tables 302 can include additional and/or alternate data fields.

The action field 314 represents zero or more actions that can be performed in connection with the packet being classified. The actions include packet editing actions and non-editing actions. The index field 316 is used in connection with segmented IPv6 addresses and, as will be discussed in more detail below, can serve to chain (link) together segments of an IP address stored across lookup tables in the multistage packet classifier.

In some embodiments, match criteria 312 comprises three components: a type field 322, a segment index field 324, and an IP address field 326. It will be understood that in other embodiments, the match criteria 312 can include components other than the three data fields shown in the figure. The type field 322 of match criteria 312 indicates the IP address type: IPv4 or IPv6. The index field 324 is an index value obtained from the lookup table in a previous stage.

The IP address field 326 of match criteria 312 comprises at least a portion of an IP address (e.g., destination IP) contained in the packet being classified. In some embodiments, the IP address field 326 is 32 bits wide and can hold an IPv4 address in its entirety.

For IPv6 addresses, the IP address field 326 can hold a 32-bit segment of the IPv6 address. In some embodiments, successive segments of a given IPv6 address can be stored in respective IP address fields across successive stages of the multistage packet classifier. For example, bits 0-31 of the IPv6 address can be stored in the lookup table in Stage 1, bits 32-63 of the IPv6 address can be stored in the lookup table in Stage 2, bits 64-95 of the IPv6 address can be stored in the lookup table in Stage 3, and bits 96-127 of the IPv6 address can be stored in the lookup table in Stage 4. Consider the following IPv6 address, for instance, expressed in hexadecimal:
2001:2ca1:5673:8a2e:0000:0000:7334:0425
   This address can be segmented (partitioned) into 32-bit segments and stored in the lookup tables 302 as shown in FIG. 3.

As noted above, in accordance with the present disclosure, the segmented IPv6 address can be chained together by the segment indices in data fields 316 and 324. As illustrated in the example in FIG. 3, for instance, the first segment of the above IPv6 address (namely 2001:2ca1) is stored in IP address field 326 of an entry in the lookup table 302 in Stage 1, and is associated with an index value ‘12’ contained in next index data field 316 of the entry. An entry in the Stage 2 lookup table contains the second segment of the above IPv6 address (namely ‘5673:8a2e’) and its index field 324 contains the value ‘12’ to provide a link back to the Stage 1 entry. The next index data field 316 contains the value ‘14’. An entry in the Stage 3 lookup table contains the third segment of the IPv6 address (namely ‘0000:0000’) and its index field 324 contains the value ‘16’ to provide a link back to the Stage 2 entry, and so on.

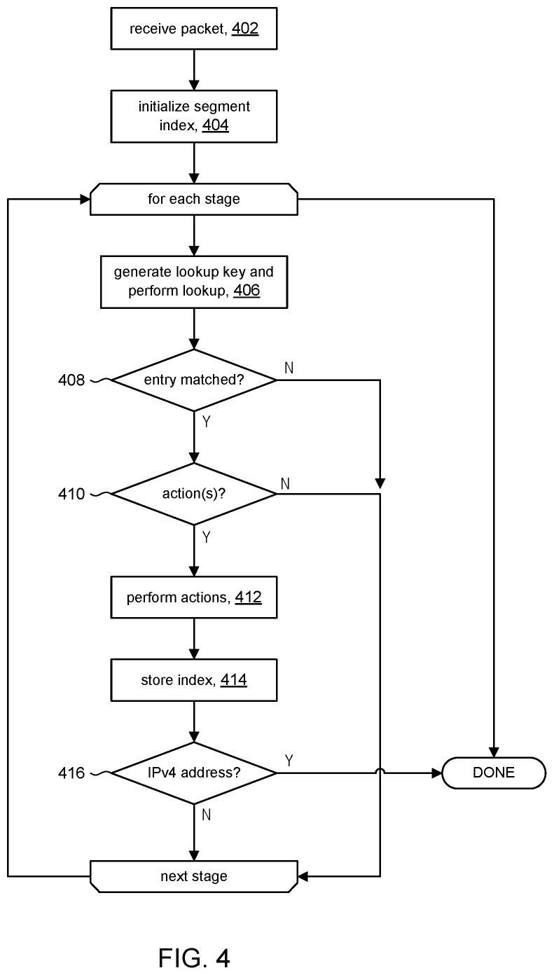

Referring to FIG. 4 and with reference to FIGS. 2 and 3, the discussion will now turn to a high-level description of processing in a network device (e.g., 100, FIG. 1) for processing in a multistage packet classifier (e.g., 200) in accordance with the present disclosure. In some embodiments, for example, the network device can include one or more processing units, which when operated, can cause the network device to perform processing in accordance with FIG. 4. Processing units (circuits) in the control plane can include general CPUs that operate by way of executing computer program code stored on a non-volatile computer readable storage medium (e.g., read-only memory); for example, CPU 108 in the control plane (FIG. 1) can be a general CPU. Processing units (circuits) in the data plane can include specialized processors such as digital signal processors, field programmable gate arrays, application specific integrated circuits, and the like, that operate by way of executing computer program code or by way of logic circuits being configured for specific operations. For example, packet processors 112a-112p in the data plane (FIG. 1) can be a specialized processor. The operation and processing blocks described below are not necessarily executed in the order shown. Operations can be combined or broken out into smaller operations in various embodiments. Operations can be allocated for execution among one or more concurrently executing processes and/or threads.

At operation 402, the network device can receive an incoming packet. The incoming packet, for example, can be an ingress packet that is received on an interface of the network device and flows directly to the packet classifier. In some embodiments, the ingress packet may be processed by upstream logic before coming into the packet classifier.

At operation 404, the network device can initialize various data in preparation for operation of the packet classifier. In some embodiments, for example, the address type (IPv4, IPv6) of the IP address in the packet can be determined or otherwise detected. The segment index (e.g., 206, FIG. 2) into the initial stage of the packet classifier can be initialized to a null (or don't care) value, and so on.

The FOR loop following operation 404 describes operations in connection with processing the packet at each stage (referred to below as “the given stage”) of the multistage packet classifier:

At operation 406, the network device can generate a lookup key (e.g., 232) and perform a look up operation on the lookup table in the given stage using the generated lookup key. The lookup can be based on an IP address (e.g., destination IP) contained in the packet. Referring to FIG. 3, in some embodiment, the lookup key can comprise an IP type (322), an index field (324), and the IP address (326). The IP type (e.g., IPv4, IPv6) can be determined when the packet is received by the network device; e.g., at operation 402. The index field can come from a matched entry found in a previous stage (operation 414). In the case of the first stage (Stage 1) of the multistage packet classifier, the index field can be a suitable null value; e.g., provided by the processing logic for Stage 1. It will be appreciated, however, that in some embodiments, that the index field in Stage 1 can be a non-null value.

Regarding the IP address field of the lookup key, the processing logic (e.g., 222, FIG. 2) in the given stage can extract the IP address from the packet. If the packet contains an IPv4 address, the processing logic in each stage can extract the full 32 bits of the IPv4 address from the packet as the IP address field.

In accordance with the present disclosure, for a packet that contains an IPv6 address, the processing logic can be configured to extract a portion (segment) of the IPv6 address from the packet. The address segment that is extracted can vary from one stage to another. For example, the processing logic in Stage 1 can be configured to extract bit locations 0-31 of an IPv6 address. The processing logic in Stage 2 can be configured to extract bit locations 32-63 of an IPv6 address. The processing logic in Stage 3 can be configured to extract bit locations 64-95 of an IPv6 address. The processing logic in Stage 4 can be configured to extract bit locations 96-127 of an IPv6 address.

The constructed lookup key comprising type, index, and address fields can be used to search the lookup table in the given stage to obtain a matched entry (e.g., 234, FIG. 2).

At decision point 408, if an entry in the lookup table matches the lookup key, then processing in the network device can continue to decision point 410. If there is no matching entry in the lookup table, then the processing can continue and proceed to the next stage (e.g., return to the top of the FOR loop).

At decision point 410, in response to finding a matched entry in the lookup table (operation 408), if there are any actions associated with the matched entry then processing can continue to operation 412. Referring for a moment to FIG. 3, the action field 314 in the matched entry can be used to determine whether or not the matched entry is associated with any actions. In some embodiments, for example, a non-null value can serve to indicate there are actions, where as a null or other invalid value can serve to indicate there are no actions. If the matched entry does not specify any actions, processing of the packet can continue and proceed to the next stage (e.g., return to the top of the FOR loop).

At operation 412, in response to there being actions associated with the matched entry (operation 410), the network device can perform the one or more actions associated with the matched entry. In some embodiments, for example, the matched entry can contain a value in the action field that points to or otherwise identifies a list of actions. In other embodiments, the action field in the matched entry can contain the list of one or more actions themselves. Actions can include, but are not limited to, editing the packet (e.g., add, strip, or edit addresses, labels, tags, etc.), dropping the packet, policing, logging information, and so on.

At operation 414, the network device can store an index value contained in the matched entry to be used in the next stage. Referring for a moment to FIG. 3, the next segment index field 316 in the matched entry stores an index value. As explained above in operation 406 and illustrated in FIG. 2 (index 206), this index value can be used to generate a lookup key for the next stage. It is noted that for the final stage of the multistage packet classifier, the index value can be discarded. It will be appreciated, however, that in some embodiments the index value from a matched entry found in the final stage can be used by downstream processing logic.

At decision point 416, if the IP address in the received packet is an IPv4 address, then in some embodiments processing in the classifier can be deemed complete, and the packet can be passed on to downstream logic for further processing and/or forwarding to the next hop. In other embodiments, processing in the classifier can continue with the next stage for both IPv4 and IPv6 addresses. Processing of the packet can continue and proceed to the next stage (e.g., return to the top of the FOR loop).

Upon completion of processing in the packet classifier, the packet can be subject to additional downstream processing, including processing in a forwarding engine to determine an interface for egress of the packet to a next hop device.

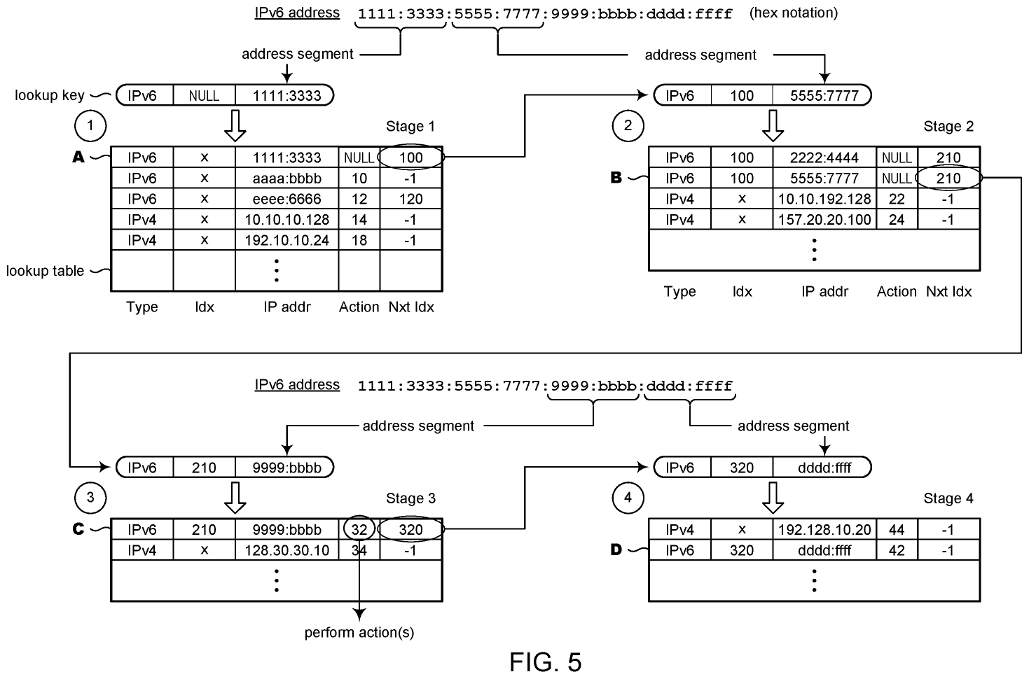

Referring to FIG. 5, the discussion will now turn to an example to illustrate the lookup operations in a multistage packet classifier in accordance with the present disclosure.

FIG. 5 shows a sequence of lookups (staged lookup) in the lookup tables of a 4-stage packet classifier for classifying a packet having an IPv6 address. The IPv6 address shown in FIG. 5 is expressed in hexadecimal notation. The processing sequence is identified by time index values represented by the circled numbers. Processing at each stage can include: (1) generating a lookup key; (2) performing a lookup in the lookup table for that stage to obtain a matched entry; and (3) processing the matched entry. The type field represents the type of IP address contained in the incoming packet. For the example in FIG. 5 the type field of the lookup key at each stage is IPv6.

### Time Index 1

At time index 1, processing can begin with Stage 1. The lookup key can be generated as follows:
The index field of the lookup key in Stage 1 can be set to a suitable null or otherwise invalid value because there is no previous stage from which to obtain an index value.
The address field can be obtained by extracting a 32-bit portion of the IPv6 address that corresponds to Stage 1. In the example shown in FIG. 5, the extracted segment that corresponds to Stage 1 comprises bit positions 0-31 in the IPv6 address, where bit 0 refers to the leftmost bit in the address.
Although not shown in the examples in FIG. 5, it will be appreciated that in some embodiments, the lookup key can include additional components.

As shown in FIG. 5, the lookup key is applied to the lookup table and matches entry A in the Stage 1 lookup table. It is noted that the full IPv6 address has not been matched at Stage 1, only a portion of the IPv6 address has been matched namely bits 0-31. Accordingly, in some embodiments, the Action field in the matched entry A can be a suitable null or otherwise invalid value to indicate that there are no actions to be performed on the partially matched address. The Nxt Idx field in the matched entry A has a value ‘100’ and can be passed on to the next stage.

### Time Index 2

At time index 2, processing can continue with Stage 2. The lookup key can be generated as follows:
The index field of the lookup key comes from the matched entry A found in Stage 1, namely the value ‘100’.
The address field can be obtained by extracting a 32-bit portion of the IPv6 address that corresponds to Stage 2. In the example shown in FIG. 5, the extracted segment that corresponds to Stage 2 comprises bit positions 32-63 in the IPv6 address.

The generated lookup key is applied to the lookup table in Stage 2 and matches entry B. As noted above, the Action field in the matched entry B can be a suitable null or otherwise invalid value to indicate there are no actions to be performed on this partially matched IPv6 address. The Nxt Idx field in the matched entry B has a value ‘210’ and can be passed on to the next stage.

In some embodiments, the Nxt Idx in the lookup table in a given stage can be used for multiple IPv6 segments. The Stage 2 lookup table, for example, includes two entries that have a Nxt Idx of ‘210’. This configuration allows for matching addresses that share a segment. The Stage 2 lookup table, for instance, will match on IPv6 addresses that begin with “1111:3333:5555:7777” and “1111:3333:2222:4444”.

### Time Index 3

At time index 3, processing can continue with Stage 3. The lookup key can be generated as follows:
The index field of the lookup key comes from the matched entry B found in Stage 2, namely the value ‘210’.
The address field can be obtained by extracting a portion of the IPv6 address that corresponds to Stage 3. In the example shown in FIG. 5, the extracted segment that corresponds to Stage 3 comprises bit positions 64-95 in the IPv6 address.

As shown in FIG. 5, the lookup key is applied to the lookup table and matches entry C in the Stage 3 lookup table. The Nxt Idx field in the matched entry C has a value ‘320’ and can be passed on to the next stage.

Regarding the Action field, in some embodiments, as shown in Stages 1 and 2 for instance, partially matched addresses may have no associated actions. In other embodiments, actions can be performed on partially matched addresses, for example to log packets that begin with a certain prefix, etc. This aspect of the present disclosure is illustrated in Stage 3 where entry C matches a partial IPv6 address and is associated with one or more actions identified by action identifier ‘32’. See also entries in the Stage 1 lookup table.

### Time Index 4

At time index 4, processing can continue with Stage 4. The lookup key can be generated as follows:
The index field of the lookup key comes from the matched entry C found in Stage 3, namely the value ‘320’.
The address field can be obtained by extracting a 32-bit portion of the IPv6 address that corresponds to Stage 4. In the example shown in FIG. 5, the extracted segment that corresponds to Stage 4 comprises bit positions 96-127 in the IPv6 address.

The generated lookup key is applied to the lookup table in Stage 4 and matches entry D. At Stage 4, the IPv6 address may be fully matched, and as such the Action field in the matched entry D can specify one or more actions to be performed on the packet. The Nxt Idx field in the matched entry D can be a suitable null or otherwise invalid value because the lookup is deemed complete. In other embodiments, the Nxt Idx can contain a non-null value that can be used for further downstream processing.

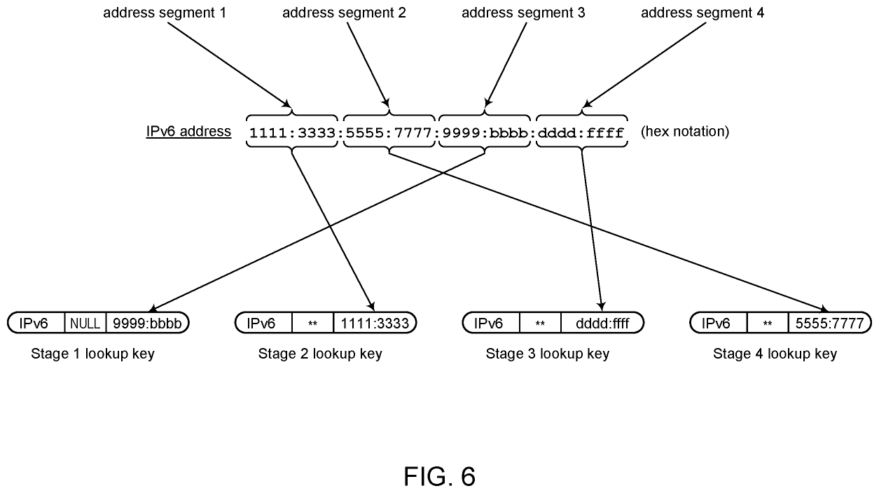

As shown in FIG. 5, in some embodiments, adjacent stages can extract adjacent segments of the address for the lookup key. For example, Stage 1 extracts bit positions 0-31 for the lookup key and the adjacent Stage 2 extracts the adjacent address segment comprising bit positions 32-63 for the lookup up; likewise with Stages 3 and 4. It is noted that in other embodiments, e.g., in a use case where the match criteria calls for an exact match of the address, the address segments of the IPv6 address need not be adjacent for adjacent stages. This is illustrated in the example shown in FIG. 6, where for instance, the address segment in the Stage 1 lookup key comes from address segment 3 in the IPv6 address, the address segment in the Stage 2 lookup key comes from address segment 1 in the IPv6 address, the address segment in the Stage 3 lookup key comes from address segment 4 in the IPv6 address, and the address segment in the Stage 4 lookup key comes from address segment 2 in the IPv6 address.

The present disclosure describes lookup tables configured with match criteria that comprise 32-bit wide IP address fields (326, FIG. 3) to store 32-bit IPv4 addresses and 32-bit segments of IPv6 addresses. This configuration fully utilizes the IP address field for both IPv4 and IPv6 addresses: 32-bit IPv4 addresses can be stored in the IP address field without leaving any unused bits and likewise 32-bit segments of an IPv6 address can be stored in the IP address field without leaving any unused bits.

Segmenting IPv6 addresses among lookup tables across the stages of a multistage packet classifier can improve scaling. Consider for example, a 4-stage packet classifier, where each lookup table holds five entries:
The packet classifier can accommodate 20 IPv4 addresses across all four lookup tables if no IPv6 addresses are present.
Conversely, the packet classifier can accommodate five IPv6 addresses if no IPv4 addresses are present, where each lookup table stores a 32-bit segment of each IPv6 address.
When there is a mix if IPv4 and IPv6 addresses, the packet classifier can accommodate:
   16 IPv4 addresses and 1 IPv6 address, where each of the four lookup tables stores four IPv4 entries and one IPv6 entry.
   12 IPv4 and 2 IPv6 addresses.
   8 IPv4 and 3 IPv6 addresses.
   etc.

It will be appreciated that in some embodiments, the match criteria can comprise differently sized IP address fields across the lookup tables, for example, to store differently sized IPv6 address segments. For example, in a 3-stage packet classifier, the match criteria in the lookup tables in the first two stages may comprise 40-bit wide IP address fields (to store 40-bit IPv6 segments) and the match criteria in the last stage comprises a 47-bit wide IP address field (to store 47-bit IPv6 segments). It will be understood that other segment size configurations are possible.

Embodiments disclosed herein generate a lookup key in a given stage n using the segment index obtained from the previous stage n−1. In other embodiments, however, the segment index used to create the lookup key can come from a prior stage n−m, where m can be other than 1. In some embodiments, the segment index in a given stage can be constructed from portions of segment indices obtained from two or more stages prior to the given stage. Suppose, for example, we have an 8-bit lookup key. The lookup key at stage n can be constructed from the upper 4 bits of a lookup key obtained from one prior stage and the lower 4 bits of a lookup key obtained from another prior stage.

In some embodiments, the segment index field 316 (FIG. 3) can be omitted. Instead, the lookup key in a given stage can be constructed using information obtained from lookup results in one or more previous stages, or determined or otherwise computed based on information obtained from lookup results in one or more previous stages.

### Further Examples

Features described above as well as those claimed below may be combined in various ways without departing from the scope hereof. The following examples illustrate some possible, non-limiting combinations:

(A1) A method in a network device for processing network traffic using a multistage packet classifier, the method comprising: receiving a data packet comprising an IP address; and processing the data packet at each stage n of the multistage packet classifier, including: searching a lookup table in the stage n to find a matched entry using at least the IP address of the data packet; and performing any actions identified in the matched entry, wherein searching the lookup table in the stage n includes: extracting an address segment from the IP address, wherein the address segment that is extracted is different from one stage to another stage; generating a lookup key comprising at least the extracted address segment; and finding the matched entry in the lookup table in the stage n using the generated lookup key.

(A2) For the method denoted as (A1), the IP address is an IPv6 address.

(A3) For the method denoted as any of (A1) through (A2), each stage n is a stage between a first stage of the multistage lookup table and a last stage of the multistage lookup table, non-inclusive.

(A4) For the method denoted as any of (A1) through (A3), the lookup key further comprises a segment index contained in an entry found in a stage prior to the stage n, wherein the matched entry found in the stage n includes a segment index that is used in a lookup key in a stage subsequent to stage n.

(A5) For the method denoted as any of (A1) through (A4), the IP address is of a first kind, the method further comprising for a second data packet comprising an IP address of a second kind processing the second data packet at each stage n of the multistage packet classifier using a second lookup key comprising the entirety of the IP address of the second kind.

(A6) For the method denoted as any of (A1) through (A5), the second lookup key further comprises a segment index contained in a matched entry from a lookup table in a stage prior to the stage n.

(A7) For the method denoted as any of (A1) through (A6), the lookup key further comprises information based on lookup results from one or more stages prior to the stage n.

(B1) A method in a network device for processing network traffic, the method comprising: receiving a data packet comprising an IP address; and sequentially searching a plurality of lookup tables including, at each lookup table: searching the lookup table using (1) a portion of the IP address in the data packet that is selected based on the lookup table being searched and (2) data contained in a matched entry found in a previously searched lookup table; and performing any actions associated with a matched entry found in the lookup table.

(B2) The method denoted as (B1), further comprising processing the data packet in a forwarding engine for egress to a next hop device.

(B3) For the method denoted as any of (B1) through (B2), the IP address is segmented in equal-sized portions.

(B4) For the method denoted as any of (B1) through (B3), the IP address is an IPv6 address.

(B5) For the method denoted as any of (B1) through (B4), the IP address is of a first kind, the method further comprising receiving a second data packet comprising an IP address of a second kind and searching at least a first lookup table among the plurality of lookup tables using the entirety of the second IP address.

(B6) For the method denoted as any of (B1) through (B5), the IP address is of a first kind, the method further comprising receiving a second data packet comprising an IP address of a second kind and searching only a first lookup table using the entirety of the second IP address.

(B7) For the method denoted as any of (B1) through (B6), searching said each lookup table further comprises using the data contained in the matched entry found in the previously searched lookup table and data contained in another matched entry found in another previously searched lookup table.

(C1) A network device comprising processing circuitry configured to: receive a data packet comprising an IP address; and sequentially process the data packet at each lookup table in a plurality of lookup tables including: search the lookup table using (1) a portion of the IP address of the data packet that is selected based on the lookup table being searched and (2) an index value contained in a matched entry found in a previously searched lookup table; and perform any actions associated with a matched entry found in the lookup table.

(C2) For the network device denoted as (C1), the IP address is segmented in equal-sized portions, wherein a unique segment of the IP address is used in the search of said each lookup table.

(C3) For the network device denoted as any of (C1) through (C2), the IP address is an IPv6 address.

(C4) For the network device denoted as any of (C1) through (C3), the processing circuitry is configured to, receive a second data packet containing an IP address of a second kind and search at least a first lookup table among the plurality of lookup tables using the entirety of the second IP address.

(C5) For the network device denoted as any of (C1) through (C4), the processing circuitry is configured to, search only the first lookup table for the second data packet comprising an IP address of the second kind.

(C6) For the network device denoted as any of (C1) through (C5), an IP address of the first kind is an IPv6 address and an IP address of the second kind is an IPv4 address.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents may be employed without departing from the scope of the disclosure as defined by the claims.

1. A method in a network device for processing network traffic using a multistage packet classifier, the method comprising:
receiving a data packet comprising an IP address; and
processing the data packet at each stage n of the multistage packet classifier, including:
searching a lookup table in the stage n to find a matched entry using at least the IP address of the data packet; and
performing any actions identified in the matched entry,
wherein searching the lookup table in the stage n includes:
extracting an address segment from the IP address, wherein the address segment that is extracted is different from one stage to another stage;
generating a lookup key comprising at least the extracted address segment; and
finding the matched entry in the lookup table in the stage n using the generated lookup key.

2. The method of claim 1, wherein the IP address is an IPv6 address.

3. The method of claim 1, wherein each stage n is a stage between a first stage of the multistage lookup table and a last stage of the multistage lookup table, non-inclusive.

4. The method of claim 1, wherein the lookup key further comprises a segment index contained in an entry found in a stage prior to the stage n, wherein the matched entry found in the stage n includes a segment index that is used in a lookup key in a stage subsequent to stage n.

5. The method of claim 1, wherein the IP address is of a first kind, the method further comprising for a second data packet comprising an IP address of a second kind processing the second data packet at each stage n of the multistage packet classifier using a second lookup key comprising the entirety of the IP address of the second kind.

6. The method of claim 5, wherein the second lookup key further comprises a segment index contained in a matched entry from a lookup table in a stage prior to the stage n.

7. The method of claim 1, wherein the lookup key further comprises information based on lookup results from one or more stages prior to the stage n.

8. A method in a network device for processing network traffic, the method comprising:
receiving a data packet comprising an IP address; and
sequentially searching a plurality of lookup tables including, at each lookup table:
searching the lookup table using (1) a portion of the IP address in the data packet that is selected based on the lookup table being searched and (2) data contained in a matched entry found in a previously searched lookup table; and
performing any actions associated with a matched entry found in the lookup table.

9. The method of claim 8, further comprising processing the data packet in a forwarding engine for egress to a next hop device.

10. The method of claim 8, wherein the IP address is segmented in equal-sized portions.

11. The method of claim 8, wherein the IP address is an IPv6 address.

12. The method of claim 8, wherein the IP address is of a first kind, the method further comprising receiving a second data packet comprising an IP address of a second kind and searching at least a first lookup table among the plurality of lookup tables using the entirety of the second IP address.

13. The method of claim 8, wherein the IP address is of a first kind, the method further comprising receiving a second data packet comprising an IP address of a second kind and searching only a first lookup table using the entirety of the second IP address.

14. The method of claim 8, wherein searching said each lookup table further comprises using the data contained in the matched entry found in the previously searched lookup table and data contained in another matched entry found in another previously searched lookup table.

15. A network device comprising processing circuitry configured to:
receive a data packet comprising an IP address; and
sequentially process the data packet at each lookup table in a plurality of lookup tables including:
search the lookup table using (1) a portion of the IP address of the data packet that is selected based on the lookup table being searched and (2) an index value contained in a matched entry found in a previously searched lookup table; and
perform any actions associated with a matched entry found in the lookup table.

16. The network device of claim 15, wherein the IP address is segmented in equal-sized portions, wherein a unique segment of the IP address is used in the search of said each lookup table.

17. The network device of claim 15, wherein the IP address is an IPv6 address.

18. The network device of claim 15, wherein the processing circuitry is configured to, receive a second data packet containing an IP address of a second kind and search at least a first lookup table among the plurality of lookup tables using the entirety of the second IP address.

19. The network device of claim 18, wherein the processing circuitry is configured to, search only the first lookup table for the second data packet comprising an IP address of the second kind.

20. The network device of claim 18, wherein an IP address of the first kind is an IPv6 address and an IP address of the second kind is an IPv4 address.
